(19) United States
(12) Patent Application Publication
(10) Pub. No.: US 2025/0111971 A1
(43) Pub. Date: Apr. 3, 2025

(54) UNDULATOR PHASE TUNING WITH MECHANICAL SHIMMING

(71) Applicant: UCHICAGO ARGONNE, LLC, Chicago, IL (US)

(72) Inventors: Maofei Qian, Darien, IL (US); Joseph Z. Xu, Naperville, IL (US); Yinghu Piao, Bolingbrook, IL (US)

(21) Appl. No.: 18/374,914

(22) Filed: Sep. 29, 2023

(51) Int. Cl. H01F 7/02; H01S 3/09; H05H 7/04

(52) U.S. Cl. CPC H01F 7/0278; H01S 3/0903; H05H 7/04

(57) ABSTRACT

Employing undulator devices as x-ray radiation sources requires high magnetic field strength and precision for generating high intensity, high coherence radiation. A magnetic field tunable undulator device is described. The undulator device includes a first magnet array disposed along a central axis of the undulator device, and a second magnet array disposed along the central axis, opposite the first magnetic array, across a gap distance. First and second structural keepers are respectively coupled to the first and second magnetic arrays to support positions of the first and second magnet arrays. A plurality of tuning elements are (i) disposed along the central axis, (ii) physically coupled to at least one of the first magnet array or the second magnet array, and (iii) configured to tune the magnetic field profile along the central axis between the first magnet array and the second magnet array.

### STATEMENT REGARDING FEDERALLY SPONSORED RESEARCH OR DEVELOPMENT

This invention was made with government support under Contract No. DE-AC02-06CH11357 awarded by the United States Department of Energy to UChicago Argonne, LLC, operator of Argonne National Laboratory. The government has certain rights in the invention.

### FIELD OF THE DISCLOSURE

The present disclosure relates to radiation sources, and in particular, to systems and methods of tuning undulator radiation sources.

### BACKGROUND

In contemporary high brightness synchrotron and free electron laser (FEL) radiation sources, undulators serve as the primary source of radiation. Undulators provide high brightness radiation beams with narrow spectral peaks, reducing unnecessary or unwanted spectral content and increasing the efficiency of the device for multiple applications. Undulators, as parts of storage ring-based synchrotron light sources or FELs, can be configured to generate radiation across a broad range of wavelengths or energies, for example, x-ray radiation with wavelengths near 0.1 nanometers, radiation in the far-infrared range from 400 to 1000 microns, or radiation having energies of 100 keV and higher at wavelengths 0.015 nm and shorter. Another feature of undulator radiation is its high collimation and coherence, and, as a result, the ability to focus x-ray beams on very small probes. There are two types of permanent magnet undulators, a planar undulator produces light with a linear polarization at many harmonics of a fundamental frequency of the undulator radiation, and a helical undulator design operates mainly at the fundamental frequency of the undulator radiation and produces light with circular polarization. Elliptically polarized light can also be obtained with variations to the undulator design. The potential for single spectral mode operation of undulators, along with the ability to create devices operating at a broad range of energies, makes undulator technologies highly attractive for a multitude of unique experiments and technological applications. For example, undulator devices provide radiation that is useful for medical imaging, biomedical applications, polarization modulation spectroscopy, optical engineering, solid state physics, biology, and metrology, among other applications.

An undulator is a magnetic device that consists of a periodic arrangement of magnets or magnetic fields. FIG. 1 illustrates a typical embodiment of an undulator device 100. An electron 102 with an initial injection path 104 is injected into the undulator device 100 with a first row of magnets 106a-j and a second row of magnets 107a-j that is apart from and opposes the first row of magnets 106a-j. The two rows of magnets 106a-j and 107a-j induce magnetic fields between them. The first set of magnets 106a and 107a with upward pointing arrows denote magnets configured to create a magnetic field with field lines going up in the plane of the page between the first set of magnets 106a and 107a, while magnets with downward pointing arrows, such as the second set of magnets 106b and 107b in each row, denote magnets configured to create a magnetic field with field lines going down in the plane of the page between the second set of magnets 106b and 107b. Magnetic fields exist between each set of magnets in FIG. 1 with fields going up or down corresponding to the respective up and down arrows on the magnets.

As the electron 102 moves into the first magnetic field between the first set of magnets 106a and 107a, the magnetic field induces a change in the direction of the trajectory of the electron 102 causing the electron 102 to move into the plane of the page in a direction orthogonal to the direction of the magnetic field lines. Once the electron 102 has moved out of the first magnetic field between the first set of magnets 106a and 107a into the second magnetic field between the second set of magnets 106b and 107b the magnetic field is reversed, or in an opposite direction, to the first magnetic field between the first set of magnets 106a and 107a. Therefore, the second magnetic field between the second set of magnets 106b and 107b causes the trajectory of the electron 102 to move in a direction opposite to that of the induced trajectory change due to the first magnetic field between magnets 106a and 107a. As the electron 102 travels from one magnetic field to the next through the undulator device 100, the periodic reversing or switching of the magnetic field direction causes the trajectory of the electron 102 to oscillate or undulate as illustrated by the oscillatory trajectory 110 shown in FIG. 1. By changing the direction or the trajectory of the electron 102, the periodic magnetic field forms the electron trajectory in an oscillatory pattern. As a result, the electron 102 emits electromagnetic radiation 112 along axis A, defined by the electron's oscillatory trajectory. The wavelength, polarization, and intensity of the emitted electromagnetic radiation 112 depend on the strength of the magnets, the period of the magnetic field oscillation, the energy (i.e., speed) of the electrons, the charge or total number of electrons, the length of the undulator, a distance 120 between the first and second rows of magnets 106a-j and 107a-j, and the direction and pattern of the periodic magnetic fields, among other factors. In some undulators, the distance 120 between the first and second rows of magnets 106a-j and 107a-j may be tunable to change the energy of the emitted electromagnetic radiation 112. In fact, characteristics of the emitted electromagnetic radiation may be tunable, for example the wavelength of the emitted electromagnetic radiation may be tuned by controlling the energy of the electrons.

The electron 102 may be one of multiple electrons in an electron beam. The intensity of the emitted electromagnetic radiation 112 is dependent on the number of electrons in an electron beam passing through the undulator device 100. For major parts of the spectrum, the radiation emitted from different electrons 102 in an electron beam passing through the undulator device 100 is incoherent due to random locations of the electrons 102 in space and time. Under special conditions, applied to the electron beam, and with a long enough undulator, the interaction of the emitted electromagnetic radiation 112 with the electrons 102 in the electron beam could cause the electrons 102 to clump into microbunches, each microbunch separated from adjacent microbunches by one wavelength of the emitted electromagnetic radiation 112. The microbunches, each positioned one wavelength from an adjacent microbunch, oscillate in phase with each other. As the intensity of the emitted electromagnetic radiation 112 increases further, the electrons are further clumped into microbunches with higher concentrations of electrons 102. The microbunches of electrons oscillating in phase with each other emit electromagnetic radiation 112 that is in phase, and allows for an overall increase, by many orders of magnitude, in the intensity of the emitted electromagnetic radiation 112.

Increasing the length of the undulator magnet can increase the total intensity of emitted radiation. Although, increasing the undulator length may contribute to other technical issues and considerations such as complicating magnet alignment and structural straightness, necessitating more stringent mechanical requirements, complicating coherence issues and tolerances, introducing greater phase error, requiring more complex cryogenic cooling modules with greater cooling capacity in the case of superconducting undulators, integrated electron beam focusing, larger phase errors across the device, and structural issues due to very strict straightness requirements.

Undulators are also known as Insertion Devices (IDs). The majority of synchrotron radiation sources, including FELs, utilize undulators with a vertically oriented magnetic field. This preferential direction is the result of the strong asymmetry; the horizontal size of the electron beam cross-section in synchrotron storage rings is typically much larger than the vertical cross-section. Additionally, current long undulators, on the order of meters in length, require extremely large bulky structures to support the straightness of the undulator. These large structures require space in the direction of the undulator design. As such, a horizontal undulator requires much more square footage of floor space as compared to a vertically stacked structure of a vertical undulator. Therefore, vertical gap undulators have been a main source of synchrotron radiation in synchrotron sources. FELs and newer generation synchrotrons have symmetric circular electron beam cross-section. Horizontally oriented undulators may provide radiation having desired polarizations for certain implementations. As such, undulators may provide radiation of various polarizations according to the needs and limitations of specific systems and experiments. Again, the additional components for achieving the ability to provide various polarizations also causes more potential error in phase of the undulator magnetic profile.

Horizontally oriented undulators provide radiation having a polarization rotated by 90° as compared to vertically oriented undulators. The rotated polarization of the radiation allows for providing radiation to x-ray beamline setups that are gravity neutral which may be required for any number of applications. Additionally, in many systems, a horizontally oriented undulator allows for significant simplifications in the construction and operation of such a setup. For example, for gravity neutral horizontal setups, structural and motor components for controlling positions of x-ray beamline optical components, experiment samples and detectors are greatly simplified allowing for more compact designs.

Modern synchrotron and FEL facilities require high precision long undulators with little phase error to generate desired intensities of radiation. Typically, long undulators are physically supported by large, heavy, and bulky mechanical supporting structures. Even with such support structures, it is still very difficult to achieve sub-microinch level precision alignment of undulator segments and magnets, which is required to generate high-intensity radiation. Any phase error along the length of the undulator decreases overall radiation output intensity. Therefore, longer undulators may suffer from increased phase errors and reduced output intensities. Additionally, tuning the gap distance 120 between magnets for adjusting the radiation energy further requires very high precision again requiring extremely bulky and heavy components. Due to the strength of the magnets used in undulators, there is a minimum distance for the gap between magnets which limits the bandwidth of generated radiation. Further, the strength of magnetic fields generated by the magnets can cause deformation and buckling of undulator components of the support structure, which renders undulator systems useless.

As described above, the strong magnets used in high-intensity radiation undulator sources makes adjusting of magnet gaps very difficult in three to five meter long, or longer, undulator devices. As such, current long undulator systems typically include notable phase error, which can increase over time given the aging or degradation of the magnets. As undulator lengths and magnet strengths increase, the phase error along the length of the undulator can greatly impact the coherence and output intensity of the resultant radiation. Correcting phase error is often a complex process that can require independent tuning of each individual magnet along the length of the undulator device. For example, modern undulator devices may employ over 500 magnets and poles along its length, with each magnet and pole being independently adjustable which requires complex, bulky, and complicated mechanical structures. Therefore, tuning the phase of an undulator device is extremely time consuming, complex, and expensive process that requires a specialist to perform the tuning. Additionally, the current methods of tuning individual magnets and poles to correct phase errors does not work on superconducting magnet undulator devices. As such, tuning of undulators can take weeks or months depending on the required time and human resources. Due to the drawbacks of current undulator systems, improved designs are desirable to provide for more precise, compact, lightweight, less expensive, and more robust tunable undulator devices.

### SUMMARY OF THE DISCLOSURE

In an embodiment, disclosed is a tunable undulator device including a first magnet array disposed along a central axis of the undulator device. A first structural keeper is physically coupled to the first magnet array to support and maintain a position of the first magnet array. A second magnet array is disposed along the central axis with the second magnet array disposed on an opposite side of the central axis from the first magnet array and a gap distance separating the second magnet array from the first magnet array. A second structural keeper is physically coupled to the second magnet array to support and maintain a position of the second magnet array. At least one strongback structure is physically coupled to the first structural keeper and the second structural keeper. The strongback structure is configured to support and maintain a position of the first structural keeper and the second structural keeper. A plurality of tuning elements are (i) disposed along the central axis, (ii) physically coupled to at least one of the first magnet array or the second magnet array, and (iii) configured to tune the magnetic field profile along the central axis between the first magnet array and the second magnet array.

In a variation of the current embodiment, each of the plurality of tuning elements is independently tunable to alter the gap distance along the central axis. In the current variation the plurality of tuning elements are disposed between the second structural keeper and the at least one strongback structure, and the plurality of tuning elements further tune a distance between the second structural keeper and the at least one strongback structure. In more variations of the current embodiment, the plurality of tuning elements are physically coupled to the first structural keeper and the at least one strongback structure. In yet more variations of the current embodiment, each of the plurality of tuning elements comprises a mechanical shim.

In variations of the current embodiment the first magnet array comprises a superconducting magnet, and the second magnet array comprises a superconducting magnet. In implementations of the current variation, the plurality of tuning elements includes a plurality of physical spacers disposed between the first magnet array and the second magnet array along the central axis with the plurality of physical spacers physically coupled to the first magnet array and the second magnet array, and a plurality of mechanical shims physically coupled to at least a portion of the plurality of physical spacers, each mechanical shim disposed between a physical spacer and at least one of the first magnet array or the second magnet array.

In variations of the current embodiment, the plurality of tuning elements comprises a non-magnetic material, and in specific examples, the plurality of tuning elements comprises steel. In yet more variations of the current embodiment, the undulator device further includes one or more magnetic shim elements disposed along the central axis with each of the one or more magnetic shim elements disposed between adjacent magnets of either the first magnet array or the second magnet array.

In a second embodiment, disclosed is a method for performing tuning of an undulator device including determining, via one or more magnetic field sensors, a magnetic field profile along a central axis of the undulator device, the magnetic field profile including a plurality of field intensities and field phases along the central axis. The method further includes determining, via one or more processors and from the magnetic field profile, (i) positions of a plurality of tuning elements along the central axis, and (ii) a tuning value for each tuning element. The undulator device includes: a first magnet array disposed along the central axis; and a second magnet array disposed along the central axis, the second magnet array disposed on an opposite side of the central axis from the first magnet array with a gap distance separating the second magnet array from the first magnet array, and wherein the plurality of tuning elements is (i) disposed along the central axis, (ii) physically coupled to at least one of the first magnet array or the second magnet array, and (iii) configured to tune the magnetic field profile along the central axis.

In a variation of the current embodiment, the plurality of tuning elements includes one or more mechanical shims, and wherein determining a tuning value for each tuning element includes determining a respective thickness for each of the one or more mechanical shims.

In more variations of the current embodiment, the plurality of tuning elements includes one or more magnetic shims, and wherein determining a tuning value comprises determining a magnetic strength of each the one or more magnetic shims.

### BRIEF DESCRIPTION OF THE DRAWINGS

FIG. 1 illustrates a typical embodiment of an undulator configuration and an electron trajectory through the undulator.

FIG. 2 is a side view of a block diagram of a tunable undulator implementing mechanical shimming, according to embodiments disclosed herein.

FIG. 3 is a close-up side-view of a section of the tunable undulator of FIG. 2.

FIG. 4 is an exploded perspective-view of an end of the tunable undulator of FIG. 2.

FIG. 5 is an image of a section of the tunable undulator of FIG. 2 showing the implementation of a magnetic shim.

FIG. 6 is an image of an end of the tunable undulator of FIG. 2 showing another implementation of a magnetic shim.

FIG. 7 is a perspective view diagram of a magnetic shim.

FIG. 8 is a perspective view diagram of a superconducting undulator with mechanical shims.

FIG. 9 is a side-view diagram of the superconducting undulator of FIG. 8.

FIG. 10 is a flow diagram of a method for performing tuning of an undulator device.

FIG. 11 is a plot of the magnetic field along the length of an undulator in meters without tuning via mechanical shimming.

FIG. 12 is a plot of phase error along the length of an undulator with respect to the phase at each of the poles of the undulator.

FIG. 13 is a plot of a desired gap deformation, Δg, along the length of an undulator.

FIG. 14A is a plot of phase error along the length of an undulator before providing tuning via mechanical shimming.

FIG. 14B is a plot of the phase error of the undulator reported in the plot of FIG. 14A after tuning via mechanical shimming has been provided.

FIG. 15 is a plot of the determined gap deformation due to the mechanical shimming along the length of the undulator reported in FIGS. 14A and 14B.

FIG. 16 is a plot of the RMS phase error of a 10 mm gap distance for an undulator before and after the tuning via mechanical shimming.

FIG. 17 is a plot of the total phase error for a 10 mm gap distance along the length of an undulator before and after tuning via mechanical shimming.

FIG. 17 is a plot of the total phase error for a 18.5 mm gap distance along the length of an undulator before and after tuning via mechanical shimming.

FIG. 19 is a plot of the gap distance along the length of an undulator before and after tuning via mechanical shimming.

FIG. 20 is a plot of the peak field flux density versus pole number along the length of the undulator, before and after tuning using mechanical shimming.

FIG. 21 is a plot of the phase error for a set of four older technology undulator devices after tuning via mechanical shimming.

FIG. 22 is a plot of the phase error for of a set of four newer technology undulator devices after tuning via mechanical shimming.

### DETAILED DESCRIPTION

Magnetic undulator devices are used to provide radiation for a multitude of purposes. For example, high-energy radiation such as x-ray radiation provided by undulators may be used for controlling, measuring, and observing chemical, material, and biological processes that may occur on the attosecond to millisecond time scale. Further, radiation may be used to probe materials at lengths of picometer and nanometer scales. Conventional tunable magnetic undulators typically have an adjustable gap separation mechanism for tuning the energy of generated radiation. The distance between the magnets, otherwise referred to as the profile of the gap between the magnets, must be controlled and maintained within less than a 10-micron tolerance of precision for proper operation of an adjustable undulator. The forces between magnets of a tunable undulator may vary by many metric tons, therefore, extremely bulky and heavy support systems are required to maintain positions of the magnets against the resultant forces between the magnetic structures. The structures required for such systems are not robust in that they must be custom designed for a given system, and are extremely large, bulky, and expensive. Further, long undulators, with separate undulator segments on the order of meters in length, require phase correctors, kickers, and other magnetic and electrical components to guide charged beams of particles due to the extreme magnetic and mechanical forces. Any errors in magnet distances or positions along the length of the undulator causes phase errors in the magnetic field profile which reduces the radiative output of the undulator, and may render a device as inoperable.

Disclosed is a tunable phase undulator device that uses mechanical shims, and magnetic shims, at various positions along an undulator to correct phase errors in an undulator device. Instead of tuning the height of each individual magnet and pole, mechanical shims are used to alter the undulator gap profile along the undulator device. As compared to other undulators, the disclosed system allows for the fabrication and tuning of more precise, compact, less expensive, and simpler device design of high precision long undulators on the order of meters in length and can maintain a magnet gap profile tolerance of 20 microns or less, and in instances, of 10 microns or less or 5 microns or less. The disclosed tunable undulator using mechanical and magnetic shims may be applied to planar, helical, and X-undulators producing radiation with variable polarizations in either vertical or horizontal orientations in beam lines. Additionally, the disclosed phase tuning methods and devices may be implemented on undulators with permanent magnets, one or more electrical magnets, or even superconducting magnets.

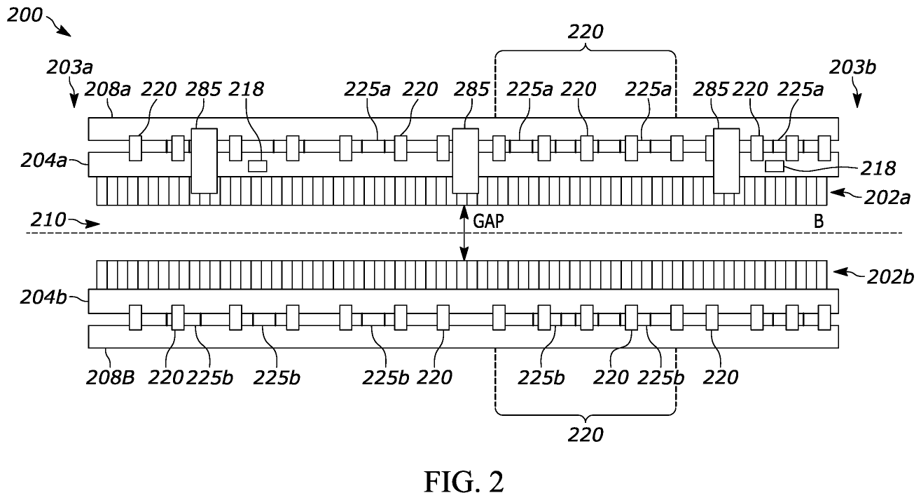

FIG. 2 is a side view of a block diagram of a tunable undulator 200 implementing mechanical shimming, according to embodiments disclosed herein. In examples, the undulator 200 will be described in reference to an adjustable gap undulator (AGU), but it should be understood that the methods, systems, and various tuning elements may be implemented in adjustable phase undulators (APUs), superconducting undulators, or another type of undulator device.

The undulator 200 includes a first magnet array 202a and a second magnet array 202b disposed across from, and opposing, the first magnet array 202a. The first and second magnet arrays 202a and 202b are disposed along a central axis B along which a beam of charged particles (e.g., electrons) may propagate. The central axis B runs along the length of the undulator 200 from a first end 203a to a second end 203b of the undulator 200. The first and second magnet arrays 202a and 202b provide attracting magnetic forces to each other with the strength of the magnetic forces being dependent on the magnetic strength of magnets of the magnet arrays 202a and 202b, and a gap 210 between the first and second magnet arrays 202a and 202b. Each of the first and second magnet arrays 202a and 202b is physically coupled to, and supported by, respective first and second keepers 204a and 204b. Each of the keepers 204a and 204b is a structure for mounting and maintaining a position of each of the magnet arrays 202a and 202b. The keepers 204a and 204b may be configured to be shiftable to alter the gap 210 between the magnet arrays 202a and 202b.

The undulator 200 includes one or more linear slides 285 that are mechanical slides that support movement of the first keeper 204a, and first magnet array 202a horizontally in the plane of the page along a longitudinal direction of the central axis B. The linear slides 285 may include one or more motors, actuators, or other mechanical devices or elements for tuning the position of the first magnet array 202a and first keeper 204a. The encoders 218 provide a measurement of the distance of movement of the first magnet array 202a in reference to the second magnet array 202b and associated components. The encoders 218 may include one or more of a linear optical encoder, a Hall Effect encoder, a magnetoresistive coder, a linear encoder, a rotary encoder, or another type of encoder or sensor for determining the position and translational distances of any of the described movable components (e.g., magnet arrays 202a and 202b, keepers 204a and 204b, etc.). Changing the horizontal position of the first magnet array 202a relative to the stationary position of the second magnet array 202b allows for one means for tuning of the phase of the undulator 200.

A first strongback 208a is physically coupled to the first keeper 204a to support and maintain a position of the first structural keeper 204a. Additionally, a second strongback 208b is physically coupled to the second keeper 204b to support and maintain a position of the second structural keeper 204b relative to the position of the first structural keeper 204a. The electromagnetic forces exerted against the first and second magnet arrays 202a and 202b during operation of the undulator require rigid structures, such as the first and second keepers 204a and 204b, and first and second strongbacks 208a and 208b to maintain the relative positions of the first and second magnet arrays 202a and 202b across from each other. While described as first and second strongbacks 208a and 208b, a single strongback structure may be physically coupled to the first and second structural keepers 204a and 204b to maintain the relative positions of the first and second magnet arrays 202a and 202b across from each other.

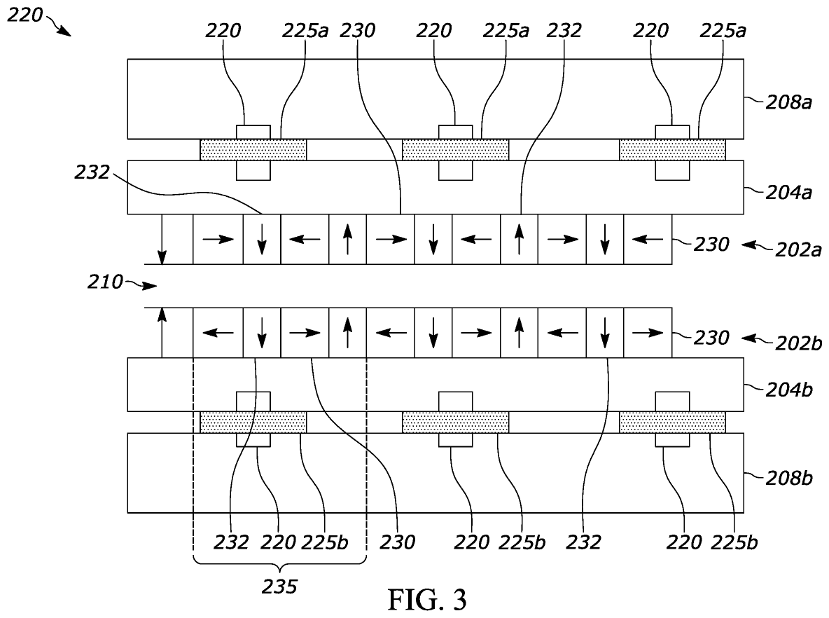

FIG. 3 is a close-up, side-view of a section, such as the section 220, of the tunable undulator 200 of FIG. 2. For clarity, the undulator 200 will continue to be described with reference to elements of both FIG. 2 and FIG. 3. A plurality of bolts 220 physically couple the first structural keeper 204a to the first strongback 208a. One or more first mechanical shims 225a are disposed between the first keeper 204a and the first strongback 208a. The first mechanical shims 225a act as physical spacers between the first keeper 204a and the first strongback 208a to adjust a position of the first keeper 204a and first magnet array 202a. The first mechanical shims 225a tune a distance of the first magnet array 202a toward the central axis B. Each of the first mechanical shims 225a may be a different thickness causing the first magnet array 202a to be closer to, or further from, the central axis B along the length of the central axis B. Changing the distance of the first magnet array 202a relative to the central axis B also alters the distance of the first magnet array 202a from the second magnet array 202b, and correspondingly, the width of the gap 210 between the first and second magnet arrays 202a and 202b along the length of the undulator 200. The varied distance of the first magnet array 202a and the second magnet array 202b allows for tuning of the magnetic field in the gap 210 using the mechanical shims 225a.

A plurality of bolts 225 additionally physically couple the second structural keeper 204b to the second strongback 208b. In examples, a plurality of second mechanical shims 225b may be disposed between the second structural keeper 204b and the second strongback 208b. The second mechanical shims 225b alter a distance of the second keeper 204b and the second magnet array 202b from the central axis B along the length of the central axis B. The first and second mechanical shims 225a and 225b may be disposed at each bolt 220, or may be disposed at different positions along the length of the undulator 200. Together, each of the first and second mechanical shims 225a and 225b may be used to tune the width of the gap 210 along the length of the undulator, and to tune the relative positions of the first and second magnet arrays 202a and 202b to further tune the strength and phase of the magnetic field generated in the gap 210. Due to imperfections in magnet strengths, magnet or pole fabrications, physical imperfections on magnets or poles, magnet alignment, etc. the magnetic field along the length of the undulator 200 may have phase offsets or phase-errors that result in a reduced intensity of output radiation, and/or reduced coherence of an output radiation beam. As such, the first and second mechanical shims 225a and 225b allow for the correction and compensation for such phase errors resulting in high output, and higher coherence, undulator devices.

In examples, each of the shims of the first and second mechanical shims 225a and 225b may include various materials such as one or more of aluminum, stainless steel or another metal, magnetic inert, or magnetic material as desired. Each of the shims may independently have a different width to cause the first and second magnet arrays 202a and 202b to have different relative positions from each other along the central axis B. As such, each of the shims of the first and second mechanical shims 225a and 225b may have a width of 5 microns, 10 microns, between 10 and 50 microns, between 50 and 100 microns, between 100 and 150 microns, greater than 100 microns. The mechanical shims 225a and 225b may each independently have lengths along the central axis B of about 1 inch, or on the order of inches or tenths of inches. Tuning the positions of the first and second magnet arrays 202a and 202b by about 10 microns, on the order of ten microns or on the order of microns such as by 5 microns allows for fine tuning of the magnetic field in the gap 210 providing higher intensity and more coherent output radiation.

It should be understood that while described herein as magnets, some of the elements of the first and second magnet arrays 202a and 202b may include high magnetic materials that are not magnets themselves. For example, some of the elements of the first and second magnet arrays 202a and 202b may be iron which is a high magnetic material that allows for higher magnetic flux through the iron material. As such, the magnets of the magnet arrays 202a and 202b will be simultaneously referred to as magnets and poles as the magnet arrays 202a and 202b may include both permanent magnets, and high magnetic materials commonly referred to as “poles.”

FIG. 3 further illustrates a series of magnets 230 and poles 232 disposed in the first and second magnet arrays 202a and 202b. Arrows on the magnets 230 and poles 232 of the magnet arrays 202a and 202b indicate the magnetization orientation. Each of the horizontal magnets 230 has a magnetic direction that is left or right in the plane of the page, while each vertical pole 232 has a magnetic direction that is up or down in the plane of the page, as indicated by corresponding arrows on each pole 232 and magnet 230. In an implementation, the vertical poles 232 were iron blocks, while the horizontally poled magnets 230 were permanent magnets. It should be understood that various poles or magnets may be used for any of the elements of the first and second magnet arrays 202a and 202b. FIG. 3 further illustrates a magnet period 235 of the first magnet array 202a. The magnet period 235 is a length along the central axis B over which four magnets (or two magnets and two poles), one of each polarity direction, of the first magnet array 202a or second magnet array 202b are traversed by an electron beam propagating along the central axis B. While not illustrated, the second magnet array 202b also has a period according to the same definition. Each of the magnet arrays 202a and 202b includes multiple periods 235 of magnets along the central axis B to form the length of the undulator 200. The magnetic period 235 may also be referred to herein as the period 235 of the undulator 200.

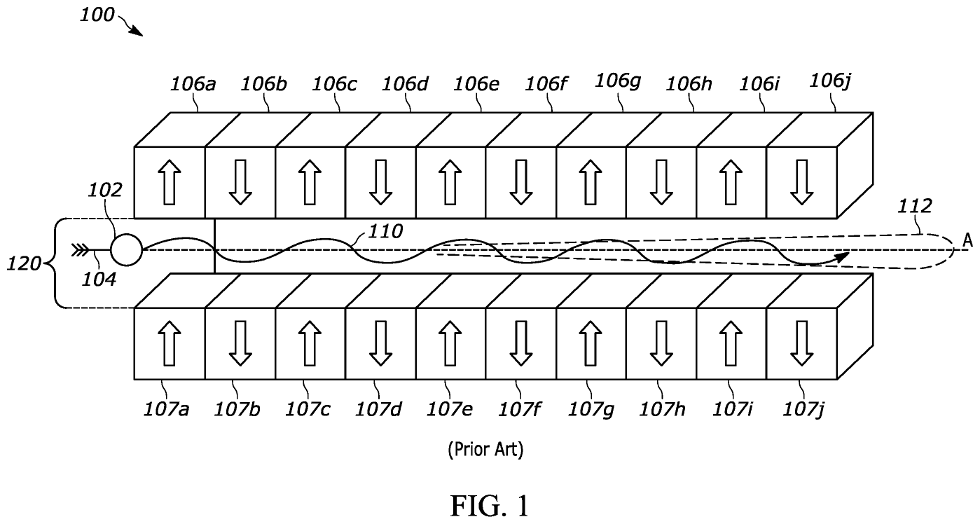

As illustrated in FIG. 1, an undulator typically maintains the magnets in positions with two up-poled magnets (i.e. “up magnets”) disposed across the gap 210 from each other, and two down-poled magnets (i.e. “down magnets”) disposed across the gap 210 from each other. In such an arrangement each left magnet is across from a right-poled magnet, and each right magnet across from a corresponding left-poled magnet. Therefore, a charged particle passing between the first and second magnet arrays 202a and 202b experiences forces into, and out of, the plane of the page causing undulations orthogonal to the plane of the page. As shown in FIG. 3, undulators typically include left- and right-poled magnets as well. The left- and right-poled magnets enhance the magnetic field between the first and second magnet arrays 202a and 202b by shaping the magnetic field to be more uniformly up and down between the magnet arrays 202a and 202b. This enhancement increases the tuning range of radiation wavelengths generated by the undulator. Such an arrangement of positions of corresponding pairs of up magnets and pairs of down magnets is referred to as an “in-phase” position, “in-phase” configuration, “paired” configuration or when the first and second magnet arrays 202a and 202b are “in-phase,” resulting in the maximum undulation amplitude of charged particles propagating along the central axis B.

The undulator 200 may be effectively tuned “out-of-phase by half period” when each of the vertical poles 232 is paired with an opposite pole (i.e., each up magnet is across the gap 210 from a down magnet, and vice versa). The “half-period” configuration may also be referred to as a “half-period” position, or when the magnet arrays 202a and 202b are “out-of-phase” or “unpaired.” In such a configuration, charged particles propagating along the central axis B will not experience any vertical forces and therefore not undulate resulting in no generation of radiation. The distance shift of the first magnet array 202a from the in-phase position to the half period out-of-phase position is half of the period 235 of the undulator 200. Positions of the first magnet array 202a between the in-phase position, and the half-period position result in radiation with varied phases which enables control of a transverse magnetic field intensity that in turn adjusts the energy of the radiation. In examples, the first magnet array 202a may be translatable by a quarter of the period 235, by half of the period 235, by a whole period 235, or by a distance equal to or greater than half of the period 235.

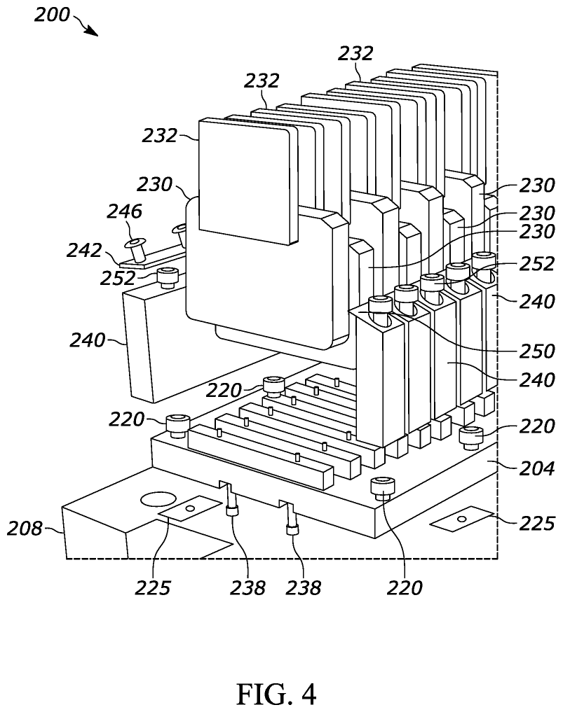

FIG. 4 is an exploded perspective-view of an end, either the first end 203a or the second end 203b of the tunable undulator 200 of FIG. 2. FIG. 4 shows a plurality of magnets 230 and poles 232 that are physically coupled to a structural keeper 204 via bolts 238. Clamps 240 are used to further hold the magnets 230 and poles 232 in place and to secure the position of each magnet 230 and pole 232. The clamps 240 may include a clamp panel 242 that attaches to the clamps 240 via clamp panel bolts 246. In examples, the clamps 240 include a top securing shelf 250 that provides pressure to the magnets 230 and poles 232 to hold the magnets 230 and poles 232 in place. In some implementations, one or more clamps 240 may not include a top securing shelf 250, and the clamp panel 242 may further act as the top securing panel to provide the further support for securing the position of the magnets 230 and poles 232. The clamps 240 may be physically coupled to the keeper 204 via clamp bolts 252.

Mechanical shims 225 may be disposed between the keeper 204 and a strongback 208. The mechanical shims 225 may be positioned along a length of the undulator 200 at each bolt 220. In other examples, the mechanical shims 225 may be position at different positions along the length of the undulator 200 that may or may not be at one of the bolts 220. The mechanical shims 225 may be a brass sheet or panel with a hole for a bolt 220 to pass through. In any examples, the mechanical shims 225 may each be different thicknesses to tune a position and orientation of the magnets 230 and poles 232 along the undulator 200.

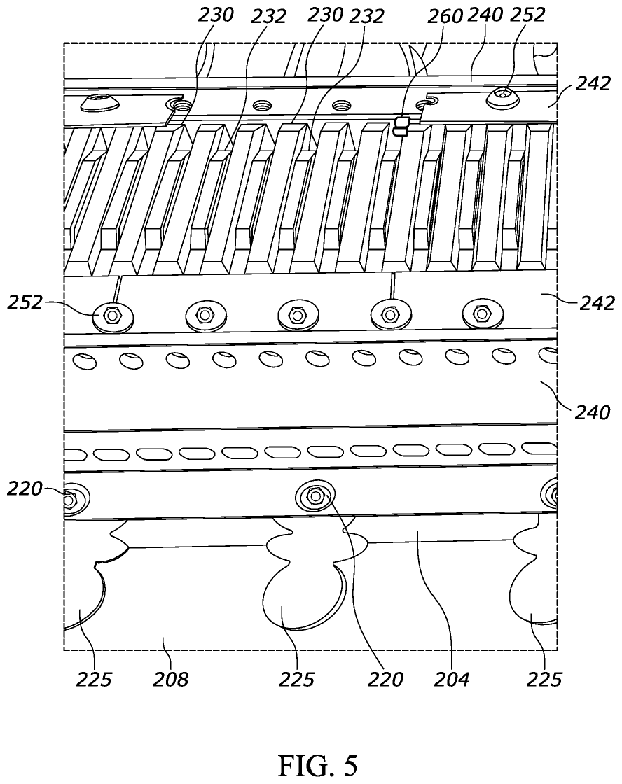

FIG. 5 is an image of a section of the tunable undulator 200 of FIG. 2 showing the implementation of a magnetic shim 260. FIG. 5 shows a series of magnets 230 and poles 232 coupled to a keeper 204 via bolts (not shown) and the clamps 240 and clamp panels 242. Bolts 252 secure the clamp panels 242 to the clamps 240 and further provide physical support for maintaining the position of the magnets 230 and poles 232. The keeper 204 is further physically coupled to the strongback 208 via the bolts 220. Mechanical shims 225 are disposed between the keeper 204 and the strongback 208 at each of the bolts 220. The bolts 220 extend through a hole in each mechanical shim 225 to couple the keeper 204 to the strongback 208. Each mechanical shim 225 has a thickness to provide a desired shift in the position of the magnets 230 and poles 232 along the length of the undulator to tune the magnetic field provided by the magnets 230 and poles 232.

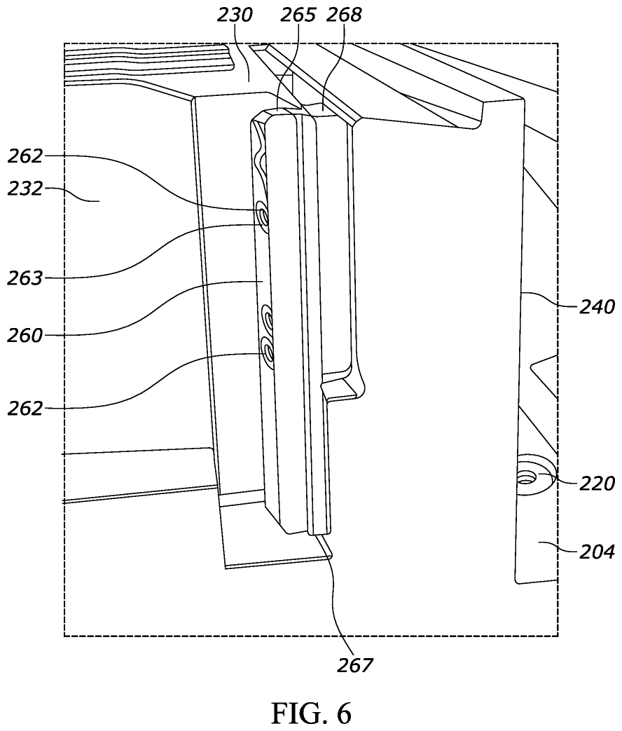

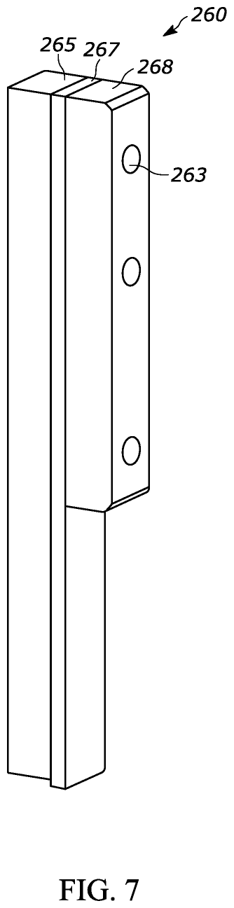

FIG. 6 is an image of an end of the tunable undulator 200 of FIG. 2 showing another implementation of a magnetic shim 260 in an undulator. In the implementation illustrated in FIG. 6, the clamps 240 are included as part of the keeper 204, and the clamps 240 are not removable from the keeper 204. FIG. 7 is a perspective view diagram of a magnetic shim 260. For completeness and clarity, the magnetic shim 260 will be described with continued reference to each of FIGS. 5, 6, and 7. The magnetic shim 260 is disposed adjacent to a pole 232 between two magnets 230 along the undulator 200. Magnetic shim bolts 262 physically couple the magnetic shim 260 to a clamp 240. The magnetic shim 260 includes a magnetic material that allows for tuning of the magnetic field through poles 232 along the undulator. For example, the magnetic shim may include steel which decreases magnetic flux through an adjacent pole 232. In examples, a magnet may be used as one or more magnetic shims 260 to increase the magnetic flux through an adjacent pole. In examples, the magnetic shims 260 may include iron, soft 1010/1008 iron, permanent magnet slugs, or another magnetic material.

The magnetic shim 260 has three parts including a long arm 265, a middle plate 267, and a short arm 268. Each of the long arm 265, middle plate 267, and short arm 268 has one or more bore holes through which a bolt may pass to secure the magnetic shim 260 to the clamp 240. The long arm 265 and the short arm 268 act as a frame and may include a non-magnetic material such as aluminum. In other examples, the long arm 265 and the short arm 268 may include other non-magnetic materials, or either the long arm 265 and/or the short arm 268 may include a magnetic material. The middle plate 267 is a magnetic material such as steel that assists in tuning of the magnetic field along the length of the undulator. The magnetic shims 260 assist in correction the trajectory of a charged particle propagating through the gap 210 along the length of the undulator 200.

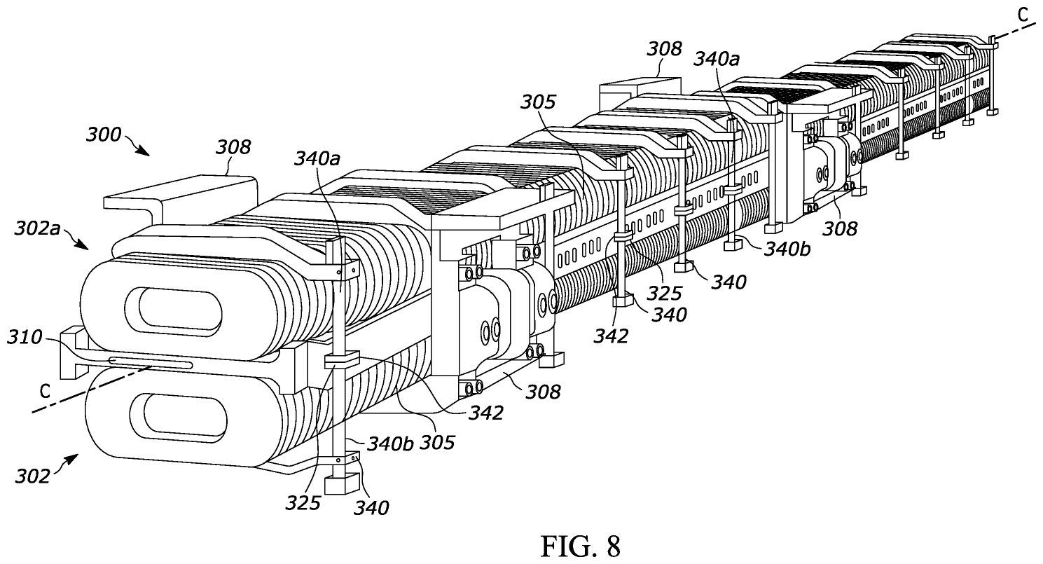

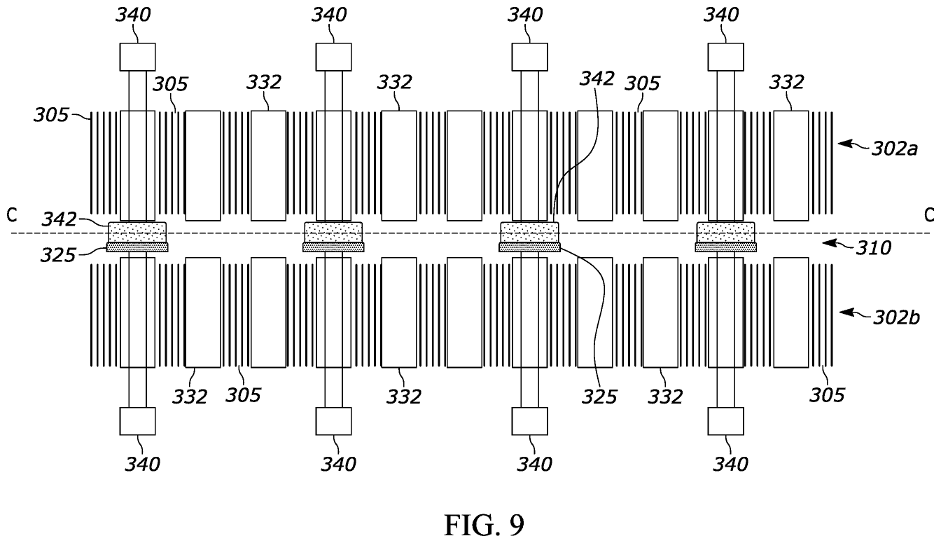

FIG. 8 is a perspective view diagram of a superconducting undulator 300, and FIG. 9 is a side-view diagram of the superconducting undulator 300 of FIG. 8. The superconducting undulator 300 includes a first magnet array 302a and a second magnet array 302b. Each magnet array 302a and 302b is disposed along a central axis C of the undulator device 300. The first magnet array 302a is disposed across from the second magnet array 302b on an opposite side of the central axis C. The first and second magnet arrays 302a and 302b generate a magnetic field in a gap 310 between the first and second magnet arrays 302a and 302b along the central axis C.

The first and second magnet arrays 302a and 302b include a plurality of magnets 330 and poles 332. Each of the magnets 330 includes a superconducting wire 305 having an electric current passing through it to generate a magnetic field. The poles 332 may include iron, another magnetic material, a magnetizable material, 1010 soft iron, vacuum, or another magnetic material. The undulator 300 includes one or more mounts 308 to mount the undulator 300 to a support structure such as a strongback or other rigid structure to support a position of the undulator 300 along a beam line or to align the undulator 300 to provide radiation to a system. The undulator 300 includes a plurality of clamps 340 that support the first and second magnet arrays 302a and 302b in positions along the central axis C. The clamps 340 each include a first clamp arm 340a, a second clamp arm 340b, and a spacer 342 that separates the magnets of the magnet arrays 302 and 302b to form a nominal gap for a particle beam to propagate through. Mechanical shims 325 are disposed between each spacer 342 and at least one of the first or second clamp arms 340a and 340b to tune the length along the overall clamp, and further, to tune the gap profile of between the first and second magnet arrays 302a and 302b, and to tune the force provided to the first and second magnet arrays 302a and 302b by the clamps 340. A thicker mechanical shim 325 results in a wider spacing of the first and second magnet arrays 302a and 302b causing a reduction in the magnetic field generated between the first and second magnet arrays 302a and 302b. Therefore, using mechanical shims of varied thicknesses enables the tuning of the magnetic field generated in the gap 310. The mechanical shims 325 may include stainless steel, or another material for tuning a distance between each spacer and at least one of the first or second clamp arms 240a and 240b. The mechanical shims 325 may be any thickness desired to result in a desired tuning gap profile for tuning the magnetic field between the first and second magnet arrays 302a and 302b. The total shim 325 and spacer 342 combined thickness is in average the nominal gap of the undulator according. The resolution of the shims 325 may be on the order of 10 microns.

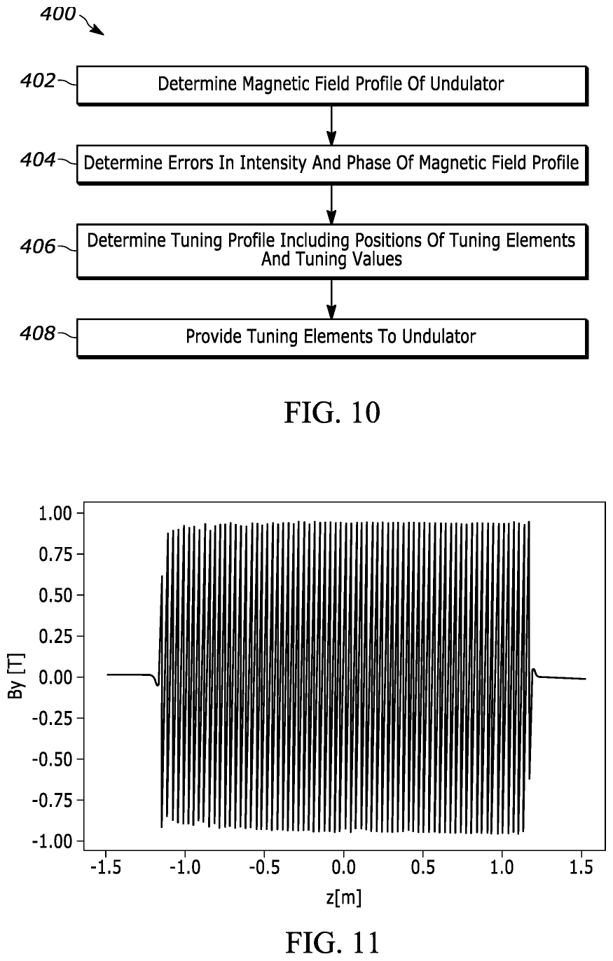

FIG. 10 is a flow diagram of a method 400 for performing tuning of an undulator device, such as the undulator 200 of FIGS. 2-4, or the undulator 300 of FIGS. 5 and 6. For simplicity, the method 400 will be described with reference to elements of the undulator 200 of FIGS. 2-4, but it should be understood that the method 400 may be performed with other undulator devices. The method 400 includes determining a magnetic field profile along the central axis B of the undulator device 200 (block 302). A magnetic field sensor may be employed to measure the magnetic field strength along the central axis. For example, a Hall sensor may be used to scan and measure the magnetic field along the central axis B. The magnetic field sensor determines a plurality of magnetic field intensities and magnetic field phases along the central axis B.

The magnetic field profile may then be analyzed by a user, or by a processor, to determine any errors in intensity or phase of the magnetic field along the central axis (block 404). The user, or processor, then determines a tuning profile that is used to correct for any errors in the intensity and/or phase of the magnetic field profile (block 406). In examples, the tuning profile may be determined by a genetic based algorithm. The tuning profile may include the positions and corresponding tuning values for a plurality of tuning elements along the central axis B. In examples, the tuning elements may include one or more mechanical shims 225, and the tuning value may be a width of each mechanical shim 225. The mechanical shims 225 may be implemented along the central axis to tune the magnetic field intensity along the central axis B. The mechanical shims 225 allow for the tuning and correction of errors in the magnetic field of the undulator resulting in a more uniform magnetic field along the length of the undulator 200. Additionally, the one or more tuning elements may include one or more magnetic shims 260 to be disposed adjacent to corresponding poles along the central axis. Each magnetic shim 260 may have a corresponding tuning value being a magnetic strength of the magnetic shim 260 for tuning the magnetic field in the gap 210 and to correct for errors in magnetic field intensity and phase along the central axis C. The method 400 further includes providing tuning elements to the undulator at the determined positions and with the respective tuning values (block 408).

A permanent magnet undulator was used to demonstrate the ability to tune the magnetic field using the mechanical and magnetic shims as described herein. The permanent magnet undulator had undergone notable demagnetization due to the use of the undulator and the natural demagnetization of permanent magnets that occurs under the radiation over time. The undulator had an initial phase error of 23°, a period length of 33 mm, a variable gap between the magnets of 10 to 30 mm, and 146 poles. The initial magnetic field along the undulator was measured to perform the method 400 of FIG. 10. FIG. 11 is a plot of the magnetic field along the length of the undulator in meters exhibiting the phase error of 23°. As shown in the data of FIG. 11, the field strength at the left of the plot is over 500 Gauss weaker.

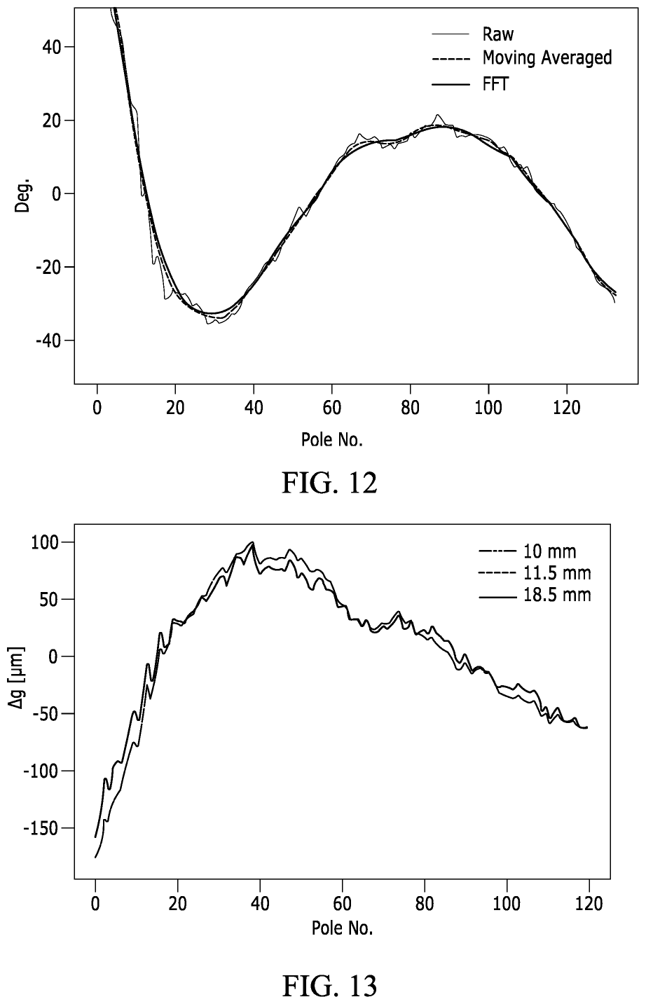

FIG. 12 is a plot of the phase error along the length of the undulator with respect to the phase at each of the poles of the undulator. To determine the phase error along the length of the undulator, a fast Fourier transform (FFT) was performed to transform the phase error into the frequency domain, and a moving average was also applied to the phase error to smooth out the phase error curve. The moving average curve was used for determining the tuning profile with respect to the phase errors along the length of the undulator. A desired gap deformation profile for tuning of the magnetic field in the gap 210 was then determined. The various positions of the mechanical shims 225 and the tuning values (e.g., widths) of each mechanical shim 225 was further determined from the desired gap deformation profile. FIG. 13 is a plot of desired gap deformation, Δg, along the undulator 200. The desired gap profile is provided with respect to the poles 232 along the length of the undulator 200. FIG. 13 shows that different gap distances of 10 mm, 11.5 mm, and 18.5 mm have different desired gap deformations to tune and correct for errors in the magnetic field generated in the gap 210. For clarity and understanding, the 10 mm and 11.5 mm desired gap profiles substantially overlap in the plot of FIG. 13. The maximum desired gap deformation reported is over 150 microns which can be accomplished using a shim of 150 microns, or about 150 microns. The shims were fabricated to match the desired gap profile to be within 10 microns of the desired thickness.

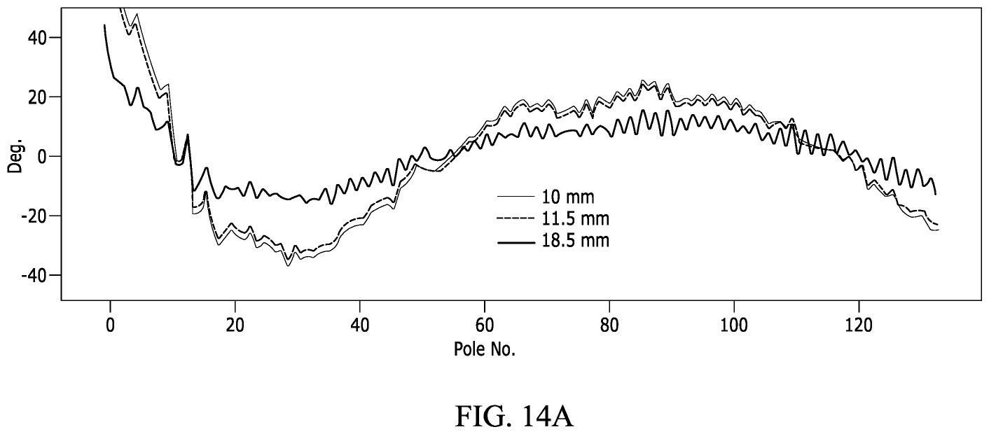

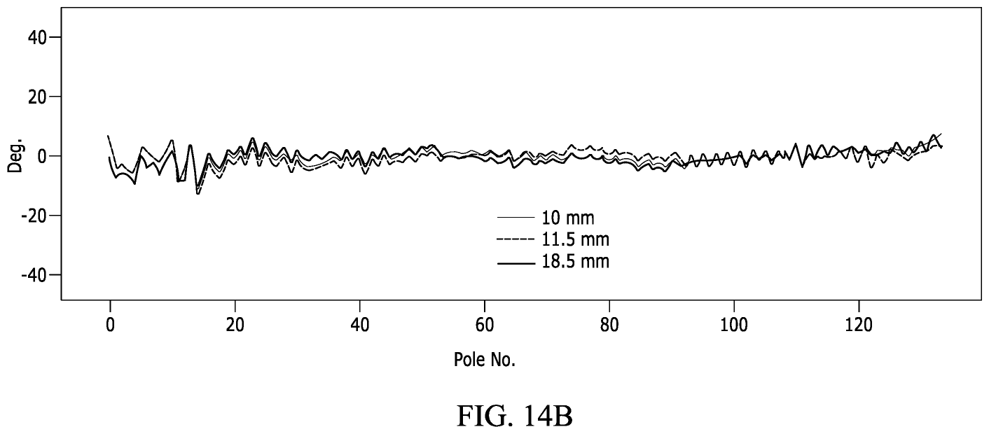

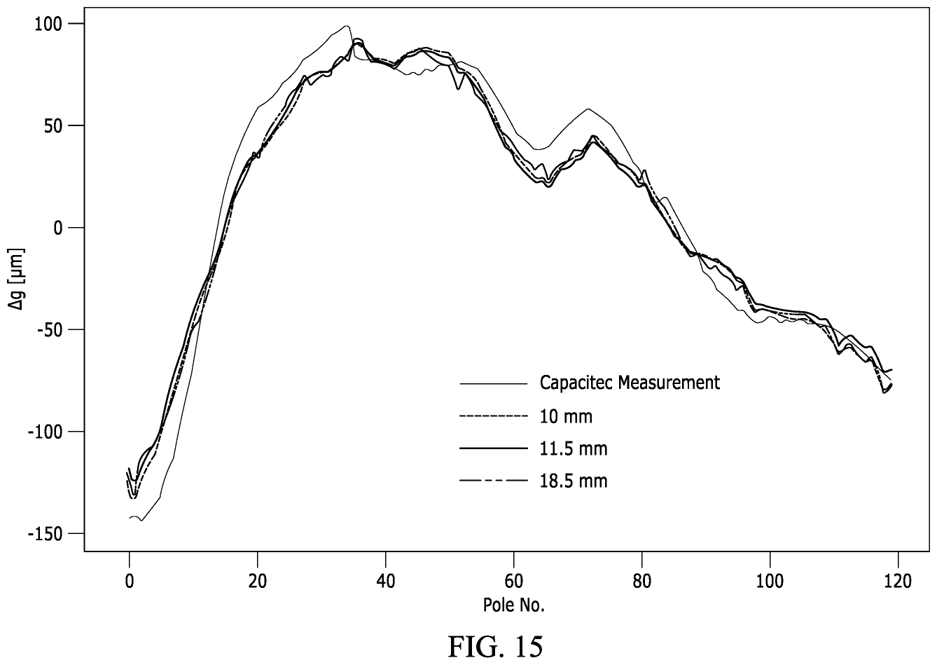

Mechanical shims 225 were provided to the undulator 200 between a keeper 204 and a strongback 208 of the undulator 200. The mechanical shims 225 were positioned at each bolt 220 along the length of the undulator 200, and each mechanical shim 225 had a thickness determined from the desired gap deformation profile. FIG. 14A is a plot of the phase error along the undulator 200 before providing tuning via mechanical shimming, and FIG. 14B is a plot of the phase error of the undulator 200 after the tuning via mechanical shimming has been provided. The RMS phase error at the 10 mm gap distance was reduced from 22.7° to 2.94°, and the tuned RMS phase error for all gap distances was less than 3°. The gap deformation was measured using a capacitance sensor. FIG. 15 is a plot of the determined gap deformation along the length of the undulator 200 due to the mechanical shimming. The gap deformation presented in FIG. 15 follows the trends of, and fairly closely matches, the desired gap deformation profile presented in FIG. 13.

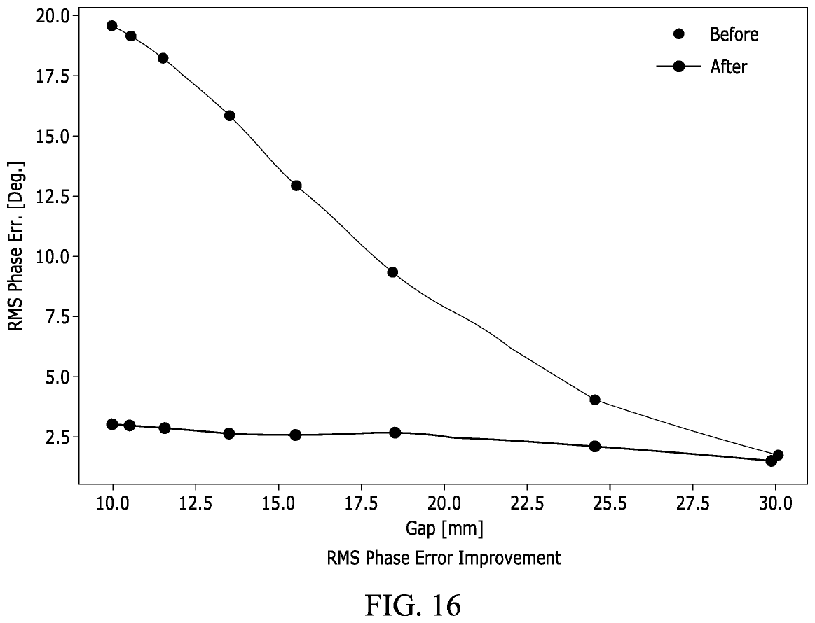

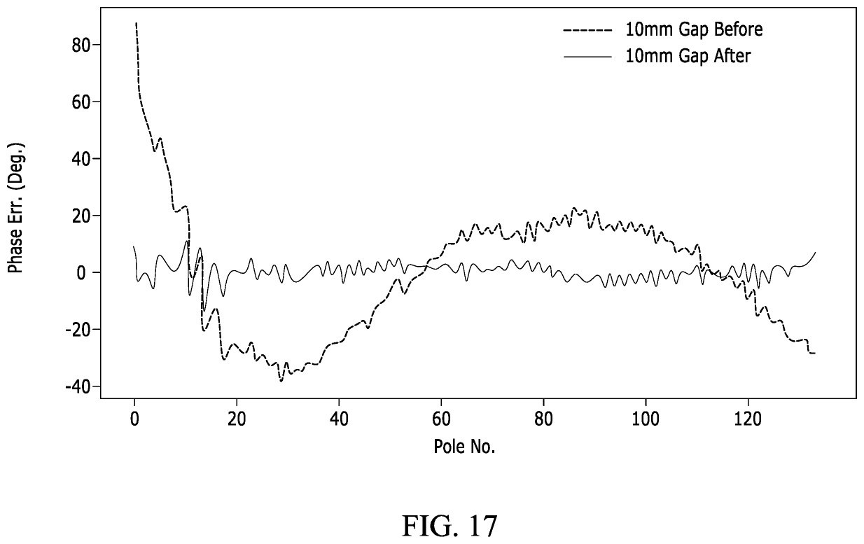

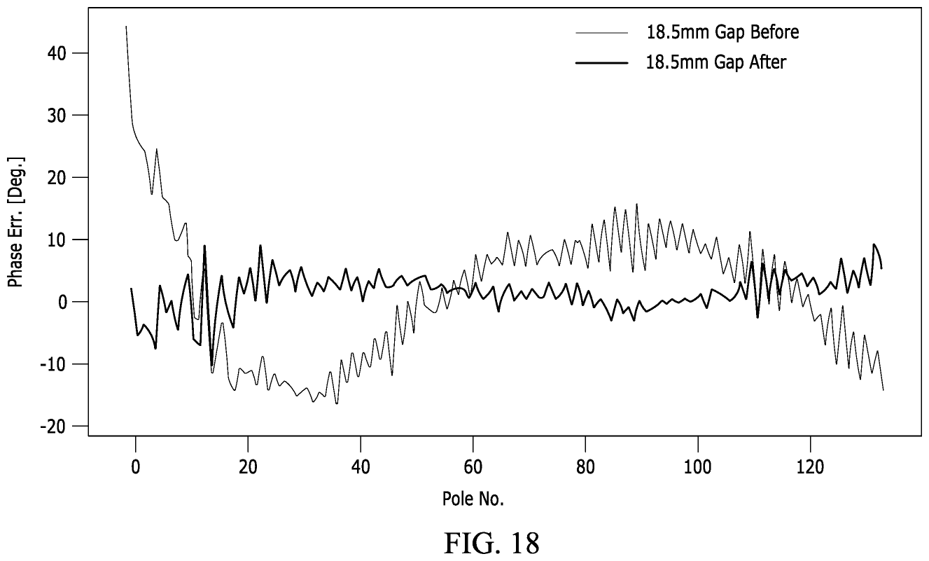

FIG. 16 is a plot of the RMS phase error of the 10 mm gap distance for the undulator before and after the tuning via mechanical shimming. The two curves presented in FIG. 16 further illustrate the amount of improvement in the overall phase error of the magnetic field along the length of the undulator. As previously mentioned, the RMS phase error was improved from around 20° to 2.9°. FIG. 17 is a plot of the overall phase error for a 10 mm gap distance along the length of the undulator, as reported with reference to pole number, before and after tuning via mechanical shimming. The local phase error shown in FIG. 17 shows notable improvement after shimming. FIG. 18 is a plot of the overall phase error for an 18.5 mm gap distance along the length of the undulator, as reported with reference to pole number, before and after tuning via mechanical shimming. Again, similarly to the data of FIG. 17, the local phase error shows notable improvement after mechanical shimming at the 18.5 mm gap. The phase error of the 18.5 mm gap follows similar trends as the phase error reported for the 10 mm gap distance, but the phase error of the 18.5 mm gap is notably noisier overall.

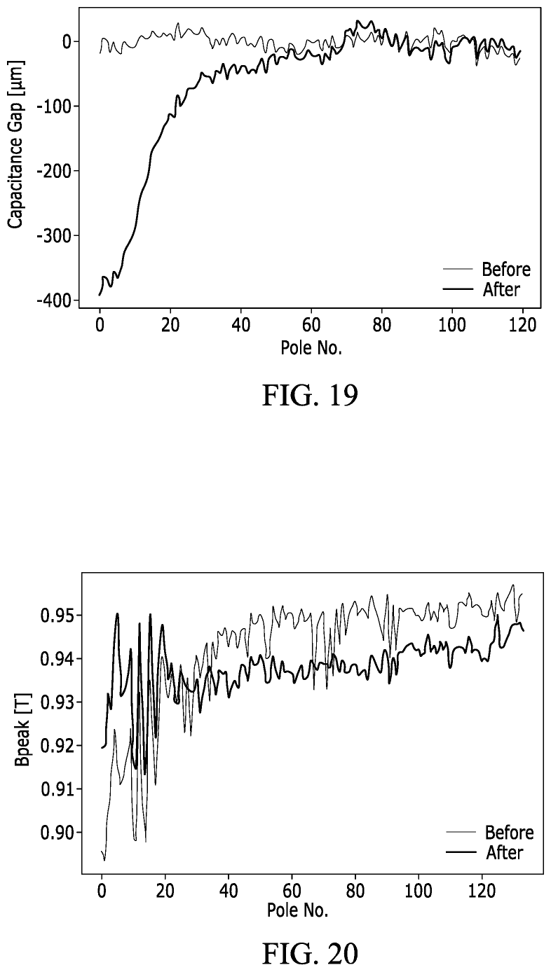

FIG. 19 is a plot of the gap distance along the length of the undulator before and after tuning via mechanical shimming. After mechanical shimming, the gap is much less straight, but the phase of the magnetic field is much more uniform, as shown in FIGS. 14B, 16, 17, and 18. The various permanent magnets may have slight position offsets, and slight differences in overall magnetic strength which result in a non-uniform magnetic field in the gap when the gap is substantially straight. As such, by altering the gap distance along the length of the undulator, as shown in the plot of FIG. 19, the magnetic field phase may be tuned to be more uniform. FIG. 20 is a plot of the peak field flux density versus pole number along the length of the undulator, before and after tuning using mechanical shims. After tuning, the overall magnetic field is more uniform over the length of the undulator.

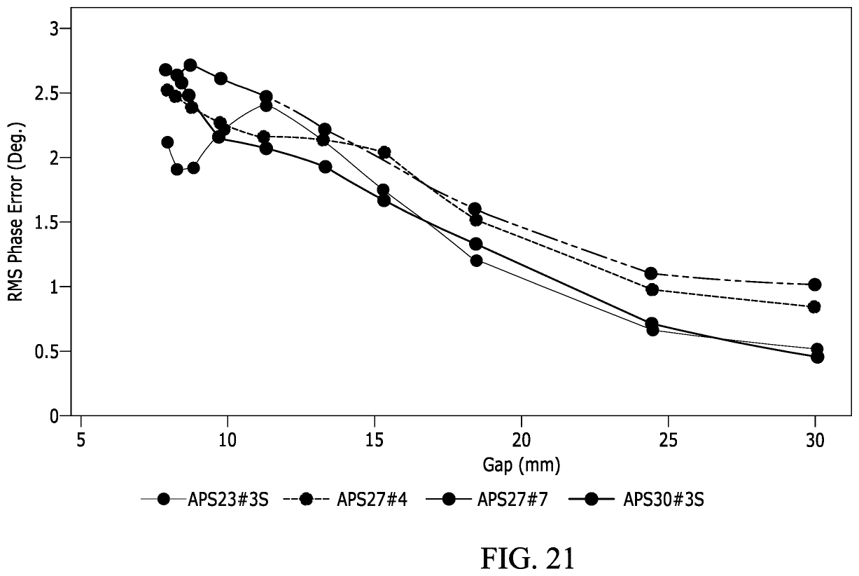

A plurality of permanent magnet undulators were tuned using the mechanical shims. The following figures present various results from the tuning of the plurality of undulator devices. FIG. 21 is a plot of the phase error for a set of four older technology undulator devices after tuning via mechanical shimming. The four devices had large initial phase errors in the range of between 7° to 20°. After tuning, each of the undulator devices exhibited overall phase errors of less than 3°, and RMS phase errors of less than 2.5° for some of the devices.

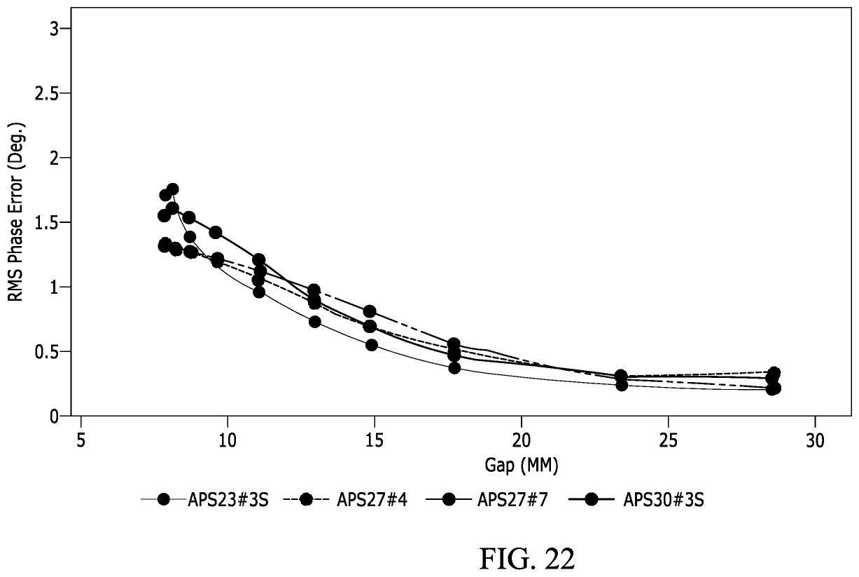

FIG. 22 is a plot of the phase error for of a set of four newer technology undulator devices after tuning via mechanical shimming. The four devices used had initial phase errors in the range of 5° to 12°. After tuning, each of the undulator devices exhibited overall phase errors of less than 1.75°, and RMS phase errors of less than 1.8° or even 1.5° for some devices. In fact, the undulators exhibited phase errors of less than 0.5°

The following list of aspects reflects a variety of the embodiments explicitly contemplated by the present disclosure. Those of ordinary skill in the art will readily appreciate that the aspects below are neither limiting of the embodiments disclosed herein, nor exhaustive of all of the embodiments conceivable from the disclosure above, but are instead meant to be exemplary in nature.

1. A tunable undulator device comprising: a first magnet array disposed along a central axis of the undulator device; a first structural keeper physically coupled to the first magnet array to support and maintain a position of the first magnet array; a second magnet array disposed along the central axis, the second magnet array disposed on an opposite side of the central axis from the first magnet array with a gap distance separating the second magnet array from the first magnet array; a second structural keeper physically coupled to the second magnet array to support and maintain a position of the second magnet array; at least one strongback structure physically coupled to the first structural keeper and second structural keeper, the strongback structure configured to support and maintain a position of the first structural keeper and the second structural keeper; and a plurality of tuning elements (i) disposed along the central axis, (ii) physically coupled to at least one of the first magnet array or the second magnet array, and (iii) configured to tune the magnetic field profile along the central axis between the first magnet array and the second magnet array.

2. The tunable undulator of aspect 1, wherein each of the plurality of tuning elements is independently tunable to alter the gap distance along the central axis.

3. The tunable undulator of either aspect 1 or aspect 2, where the plurality of tuning elements are disposed between the second structural keeper and the at least one strongback structure, and wherein the plurality of tuning elements further tune a distance between the second structural keeper and the at least one strongback structure.

4. The tunable undulator of any of aspects 1 to 3, further comprising a plurality of tuning elements physically coupled to the first structural keeper and the at least one strongback structure.

5. The tunable undulator of any of aspects 1 to 4, wherein each of the plurality of tuning elements comprises a mechanical shim.

6. The tunable undulator of aspect 1, wherein the first magnet array comprises a superconducting magnet, and the second magnet array comprises a superconducting magnet.

7. The tunable undulator of aspect 1 or aspect 6, wherein the plurality of tuning elements comprises: a plurality of physical spacers disposed between the first magnet array and the second magnet array along the central axis, the plurality of physical spacers physically coupled to the first magnet array and the second magnet array; and a plurality of mechanical shims physically coupled to at least a portion of the plurality of physical spacers, each mechanical shim disposed between a physical spacer and at least one of the first magnet array or the second magnet array.

8. The tunable undulator of any of aspects 1 to 7, wherein the plurality of tuning elements comprises a non-magnetic material.

9. The tunable undulator of any of aspects 1 to 8, wherein the plurality of tuning elements comprises steel.

10. The tunable undulator of any of aspects 1 to, further comprising one or more magnetic shim elements disposed along the central axis, each of the one or more magnetic shim elements disposed between adjacent magnets of either the first magnet array or the second magnet array.

11. The tunable undulator of aspect 10, wherein the one or more magnetic shim elements comprises steel or a magnetic slug.

12. The tunable undulator of any of aspects 1 to 11, wherein the (i) first magnet array, (ii) second magnet array, and (ii) plurality of tuning elements are configured to generate a magnetic field along the central axis having a phase error of less than 3 degrees.

13. A method for performing tuning of an undulator device, the method comprising: determining, via one or more magnetic field sensors, a magnetic field profile along a central axis of the undulator device, the magnetic field profile including a plurality of field intensities and field phases along the central axis; and determining, via one or more processors and from the magnetic field profile, (i) positions of a plurality of tuning elements along the central axis, and (ii) a tuning value for each tuning element, and wherein the undulator device comprises: a first magnet array disposed along the central axis; and a second magnet array disposed along the central axis, the second magnet array disposed on an opposite side of the central axis from the first magnet array with a gap distance separating the second magnet array from the first magnet array, and wherein the plurality of tuning elements is (i) disposed along the central axis, (ii) physically coupled to at least one of the first magnet array or the second magnet array, and (iii) configured to tune the magnetic field profile along the central axis.

14. The method of aspect 13, wherein the plurality of tuning elements comprises one or more mechanical shims, and wherein determining a tuning value for each tuning element comprises determining a respective thickness for each of the one or more mechanical shims.

15. The method of either of aspect 13 or aspect 14, wherein the plurality of tuning elements comprises one or more magnetic shims, and wherein determining a tuning value comprises determining a magnetic strength of each the one or more magnetic shims.

16. The method of any of aspects 13 to 15, wherein the first magnet array comprises a superconducting magnet, and wherein the second magnet array comprises a superconducting magnet.

17. The method of any of aspects 13 to 16, wherein each of the plurality of tuning elements is independently tunable to alter the gap distance along the central axis.

What is claimed is:

1. A tunable undulator device comprising:
a first magnet array disposed along a central axis of the undulator device;
a first structural keeper physically coupled to the first magnet array to support and maintain a position of the first magnet array;
a second magnet array disposed along the central axis, the second magnet array disposed on an opposite side of the central axis from the first magnet array with a gap distance separating the second magnet array from the first magnet array;
a second structural keeper physically coupled to the second magnet array to support and maintain a position of the second magnet array;
at least one strongback structure physically coupled to the first structural keeper and second structural keeper, the strongback structure configured to support and maintain a position of the first structural keeper and the second structural keeper; and
a plurality of tuning elements (i) disposed along the central axis, (ii) physically coupled to at least one of the first magnet array or the second magnet array, and (iii) configured to tune the magnetic field profile along the central axis between the first magnet array and the second magnet array.

2. The tunable undulator of claim 1, wherein each of the plurality of tuning elements is independently tunable to alter the gap distance along the central axis.

3. The tunable undulator of claim 1, where the plurality of tuning elements are disposed between the second structural keeper and the at least one strongback structure, and wherein the plurality of tuning elements further tune a distance between the second structural keeper and the at least one strongback structure.

4. The tunable undulator of claim 1, further comprising a plurality of tuning elements physically coupled to the first structural keeper and the at least one strongback structure.

5. The tunable undulator of claim 1, wherein each of the plurality of tuning elements comprises a mechanical shim.

6. The tunable undulator of claim 1, wherein the first magnet array comprises a superconducting magnet, and the second magnet array comprises a superconducting magnet.

7. The tunable undulator of claim 1, wherein the plurality of tuning elements comprises:
a plurality of physical spacers disposed between the first magnet array and the second magnet array along the central axis, the plurality of physical spacers physically coupled to the first magnet array and the second magnet array; and
a plurality of mechanical shims physically coupled to at least a portion of the plurality of physical spacers, each mechanical shim disposed between a physical spacer and at least one of the first magnet array or the second magnet array.

8. The tunable undulator of claim 1, wherein the plurality of tuning elements comprises a non-magnetic material.

9. The tunable undulator of claim 1, wherein the plurality of tuning elements comprises steel.

10. The tunable undulator of claim 1, further comprising one or more magnetic shim elements disposed along the central axis, each of the one or more magnetic shim elements disposed between adjacent magnets of either the first magnet array or the second magnet array.

11. The tunable undulator of claim 10, wherein the one or more magnetic shim elements comprises steel or a magnetic slug.

12. The tunable undulator of claim 1, wherein the (i) first magnet array, (ii) second magnet array, and (ii) plurality of tuning elements are configured to generate a magnetic field along the central axis having a phase error of less than 3 degrees.

13. A method for performing tuning of an undulator device, the method comprising:
determining, via one or more magnetic field sensors, a magnetic field profile along a central axis of the undulator device, the magnetic field profile including a plurality of field intensities and field phases along the central axis; and
determining, via one or more processors and from the magnetic field profile, (i) positions of a plurality of tuning elements along the central axis, and (ii) a tuning value for each tuning element, and wherein the undulator device comprises:
a first magnet array disposed along the central axis; and
a second magnet array disposed along the central axis, the second magnet array disposed on an opposite side of the central axis from the first magnet array with a gap distance separating the second magnet array from the first magnet array, and wherein the plurality of tuning elements is (i) disposed along the central axis, (ii) physically coupled to at least one of the first magnet array or the second magnet array, and (iii) configured to tune the magnetic field profile along the central axis.

14. The method of claim 13, wherein the plurality of tuning elements comprises one or more mechanical shims, and wherein determining a tuning value for each tuning element comprises determining a respective thickness for each of the one or more mechanical shims.

15. The method of claim 13, wherein the plurality of tuning elements comprises one or more magnetic shims, and wherein determining a tuning value comprises determining a magnetic strength of each the one or more magnetic shims.

16. The method of claim 13, wherein the first magnet array comprises a superconducting magnet, and wherein the second magnet array comprises a superconducting magnet.

17. The method of claim 13, wherein each of the plurality of tuning elements is independently tunable to alter the gap distance along the central axis.
